(19) United States
(12) Patent Application Publication
(10) Pub. No.: US 2008/0123223 A1
(43) Pub. Date: May 29, 2008

(54) TUNNELING MAGNETIC SENSOR INCLUDING TIO-BASED INSULATING BARRIER LAYER AND METHOD FOR PRODUCING THE SAME

(75) Inventors: Yosuke Ide, Niigaka-ken (JP); Naoya Hasegawa, Niigata-ken (JP); Masamichi Saito, Niigata-ken (JP); Masahiko Ishizone, Niilgata-ken (JP); Ryo Nakabayashi, Niigaka-ken (JP); Kazumasa Nishimura, Niigaka-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/771,876

(22) Filed: Jun. 29, 2007

(30) Foreign Application Priority Data
Jun. 30, 2006 (JP) 2006-180619
Nov. 22, 2006 (JP) 2006-315961

(51) Int. Cl. G11B 5/33; G11B 5/127; H04R 31/00

(52) U.S. Cl. 360/324.2; 29/603.07

(57) ABSTRACT

A tunneling magnetic sensor has a multilayer part including, from bottom to top, a pinned magnetic layer, an insulating barrier layer, and a free magnetic layer. The insulating barrier layer is formed of titanium magnesium oxide (TiMgO) and contains magnesium in an amount of about 4 to 20 atomic percent based on 100 atomic percent of the total content of titanium and magnesium. The insulating barrier layer thus does not have a high concentration of magnesium. This tunneling magnetic sensor can provide a higher rate of resistance change (ΔR/R) at a lower RA (the product of sensor resistance, R, and sensor area, A) than known tunneling magnetic sensors.

### CLAIM OF PRIORITY

This application claims benefit of the Japanese Patent Application No. 2006-180619 filed on Jun. 30, 2006 and the Japanese Patent Application No. 2006-315961 filed on Nov. 22, 2006, which are hereby incorporated by reference.

### BACKGROUND OF THE INVENTION

1. Field of the Invention

The present invention relates to magnetic sensors utilizing a tunneling effect for use in magnetic sensing apparatuses, including magnetic playback apparatuses such as hard disk drives. In particular, the invention relates to a tunneling magnetic sensor capable of providing a high rate of resistance change (ΔR/R) at low RA (the product of sensor resistance, R, and sensor area, A) and a method for producing the tunneling magnetic sensor.

2. Description of the Related Art

A tunneling magnetic sensor, which utilizes a tunneling effect to cause a resistance change, includes a pinned magnetic layer, a free magnetic layer, and an insulating barrier layer (tunneling barrier layer) disposed therebetween. If the magnetization of the free magnetic layer is antiparallel to that of the pinned magnetic layers a tunneling current flowing through the insulating barrier layer is minimized, meaning that the resistance is maximized. If the magnetization of the free magnetic layer is parallel to that of the pinned magnetic layer, the tunneling current is maximized, meaning that the resistance is minimized.

Based on this principle, a change in electrical resistance is detected as a voltage change when an external magnetic field changes the magnetization of the free magnetic layer. The tunneling magnetic sensor thus senses a leakage magnetic field from a recording medium.

Japanese Unexamined Patent Application Publication No. 2002-232040 (Patent Document 1) discloses a tunneling magnetic sensor including an insulating barrier layer having a two-layer structure. The constituent elements of the insulating barrier layer are disclosed in, for example, claim 8 of the publication.

U.S. Patent application Publication No. 2006/0098354 A1 (Patent Document 2) discloses a tunneling magnetic sensor including an insulating barrier layer formed of MgO or MgZnO.

One of the challenges of tunneling magnetic sensors is to provide a high rate of resistance change (ΔR/R) within a low range of RA. High RA causes problems such as difficulty of high-speed data transmission.

A playback head capable of providing a high rate of resistance change (ΔR/R) only at high RA cannot provide high performance. Accordingly, a magnetic sensor satisfactory in terms of both RA and the rate of resistance change (ΔR/R) has been demanded.

This challenge is not discussed in any of the above patent documents.

Although Patent Document 1 discloses many constituent elements for the insulating barrier layer, only AlOₓ is actually used in experiments, and the characteristics of insulating barrier layers formed of other constituent elements remain unknown. In addition, this publication has no detailed description as to the concentrations of two or more constituent elements selected from, for example, the elements disclosed in Claim 8.

Patent Document 2 discusses an insulating barrier layer formed of MgO. MgO can provide a relatively high rate of resistance change (ΔR/R), although the use of MgO results in high RA (specifically, 7 Ωμm² or more). Also, MgO undesirably has a deliquescent property.

### SUMMARY OF THE INVENTION

To solve the above problems, the present invention provides a tunneling magnetic sensor capable of providing a higher rate of resistance change (ΔR/R) at a lower RA than known tunneling magnetic sensors and a method for producing such a tunneling magnetic sensor.

A tunneling magnetic sensor according to the present invention includes, from bottom to top, a first magnetic layer, an insulating barrier layer, and a second magnetic layer. One of the first and second magnetic layers is a pinned magnetic layer whose magnetization direction is fixed, and the other magnetic layer is a free magnetic layer whose magnetization direction is changed by an external magnetic field. The insulating barrier layer is formed of titanium magnesium oxide (TiMgO) and contains magnesium in an amount of about 4 to about 20 atomic percent based on 100 atomic percent of the total content of titanium and magnesium.

This tunneling magnetic sensor can provide a higher rate of resistance change (ΔR/R) at a lower RA than known tunneling magnetic sensors. Specifically, the RA can be controlled within the range of about 2 to about 7 Ωμm², preferably about 2 to about 5 Ωμm², more preferably about 2 to about 4 Ωμm², most preferably about 2 to about 3 Ωμm². In addition, the tunneling magnetic sensor can provide a rate of resistance change (ΔR/R) of about 20% or more, preferably about 25% or more.

An insulating barrier layer having a magnesium concentration exceeding the above range is undesirable because it tends to exhibit a lower rate of resistance change (ΔR/R) than a titanium oxide (TiO) insulating barrier layer. As demonstrated in the experiment described later, an insulating barrier layer having a magnesium concentration within the above range can provide a higher rate of resistance change (ΔR/R) than a TiO insulating barrier layer within the same range of RA.

In the present invention, the content of magnesium is preferably about 4 to about 15 atomic percent.

In the present invention, the insulating barrier layer may include a TiO layer and a magnesium oxide (MgO) layer disposed in at least one site of the inside, top surface, and bottom surface of the TiO layer.

Preferably, the MgO layer is disposed on one or both of the top and bottom surfaces of the TiO layer to more successfully increase the rate of resistance change (ΔR/R). MgO is more capable of increasing the rate of resistance change (ΔR/R) than TiO. Accordingly, the rate of resistance change (ΔR/R) can be successfully increased by forming the MgO layer at one or both of the interfaces between the insulating barrier layer and the first magnetic layer and between the insulating barrier layer and the second magnetic layer.

In the present invention, the MgO layer is preferably discontinuously formed. In other words, the MgO layer preferably has such a small thickness that it becomes discontinuous.

In the present invention, the insulating barrier layer may have a region where the concentration of magnesium varies in a thickness direction. The concentration of magnesium tends to be varied during, for example, annealing in the production of the tunneling magnetic sensor. Preferably, the concentration of magnesium is higher near one or both of the top and bottom surfaces of the insulating barrier layer than in the other region. This contributes to an increase in the rate of resistance change (ΔR/R).

In the present invention, the insulating barrier layer may be formed by oxidizing a TiMg alloy.

A process for producing a tunneling magnetic sensor according to the present invention includes the steps of (a) forming a multilayer structure including at least one titanium layer and at least one magnesium layer on a first magnetic layer; (b) oxidizing the titanium layer and the magnesium layer to form an insulating barrier layer comprising TiMgO; and (c) forming a second magnetic layer on the insulating barrier layer. The thicknesses of the titanium layer and the magnesium layer are controlled so that the content of magnesium is about 4 to about 20 atomic percent based on 100 atomic percent of the total content of titanium and magnesium.

The above process allows formation of a TiMgO insulating barrier layer containing magnesium in an amount of about 4 to about 20 atomic percent based on 100 atomic percent of the total content of titanium and magnesium. Accordingly, a tunneling magnetic sensor capable of providing a higher rate of resistance change (ΔR/R) at a lower RA than known tunneling magnetic sensors can be successfully and easily produced by the above process.

Preferably, in step (a), the average thickness of the multilayer structure is controlled within the range of about 4 to about 7 Å, and the average thickness of the magnesium layer (or the average total thickness of the magnesium layers) is controlled within the range of about 0.3 to about 2.0 Å. In this case, the content of magnesium can be controlled within the range of about 4 to about 20 atomic percent based on 100 atomic percent of the total content of titanium and magnesium.

More preferably, in step (a), the thicknesses of the titanium layer and the magnesium layer are controlled so that the content of magnesium is about 4 to about 15 atomic percent based on 100 atomic percent of the total content of titanium and magnesium. In this case, it is preferred that in step (a), the average thickness of the multilayer structure be controlled within the range of about 4 to about 7 Å and the average thickness of the magnesium layer (or the average total thickness of the magnesium layers) be controlled within the range of about 0.3 to about 1.5 Å.

In the present invention, preferably, the magnesium layer is formed either between the first magnetic layer and the titanium layer or between the second magnetic layer and the titanium layer, or is formed both between the first magnetic layer and the titanium layer and between the second magnetic layer and the titanium layer. This contributes to an increase in the rate of resistance change (ΔR/R).

In the present invention, preferably, a TiMg alloy layer is formed on the first magnetic layer instead of the multilayer structure in step (a) and is oxidized in step (b). The TiMg alloy layer contains magnesium in an amount of about 4 to about 20 atomic percent based on 100 atomic percent of the total content of titanium and magnesium. More preferably, the TiNg alloy layer formed on the first magnetic layer in step (a) contains magnesium in an amount of about 4 to about 15 atomic percent.

The tunneling magnetic sensor according to the present invention can provide a higher rate of resistance change (ΔR/R) at a lower RA than known tunneling magnetic sensors.

### BRIEF DESCRIPTION OF THE DRAWINGS

FIG. 1 is a sectional view of a tunneling magnetic sensor according to an embodiment of the present invention which is taken in a direction parallel to a surface of the magnetic sensor opposite a recording medium;

FIG. 2 is another sectional view of the tunneling magnetic sensor which is taken in the direction parallel to the surface of the magnetic sensor opposite a recording medium;

FIG. 3 is a partial enlarged sectional view of an insulating barrier layer according to this embodiment;

FIG. 4 shows a partial enlarged sectional view of another insulating barrier layer according to this embodiment and a graph showing variations in the concentration of magnesium;

FIG. 5 is a diagram illustrating a step of a process for producing the tunneling magnetic sensor according to this embodiment (a sectional view of the tunneling magnetic sensor during the production process which is taken in the direction parallel to the surface of the magnetic sensor opposite a recording medium);

FIG. 6 is a diagram illustrating a step following the step of FIG. 5 (a sectional view of the tunneling magnetic sensor during the production process which is taken in the direction parallel to the surface of the magnetic sensor opposite a recording medium);

FIG. 7 is a diagram illustrating a step following the step of FIG. 6 (a sectional view of the tunneling magnetic sensor during the production process which is taken in the direction parallel to the surface of the magnetic sensor opposite a recording medium);

FIG. 8 is a diagram illustrating a step following the step of FIG. 7 (a sectional view of the tunneling magnetic sensor during the production process which is taken in the direction parallel to the surface of the magnetic sensor opposite a recording medium);

FIG. 9 is a graph showing the relationship between the RA and rate of resistance change (ΔR/R) of tunneling magnetic sensors including an insulating barrier layer formed by oxidizing a multilayer structure of titanium and magnesium (Samples 1 to 6) or a single titanium layer (Sample 7); and

FIG. 10 is a graph showing the relationship between the RA and rate of resistance change (ΔR/R) of tunneling magnetic sensors including an insulating barrier layer formed by oxidizing a multilayer structure of titanium and magnesium (Samples 8 to 11) or a single titanium layer (Sample 12).

### DESCRIPTION OF THE PREFERRED EMBODIMENTS

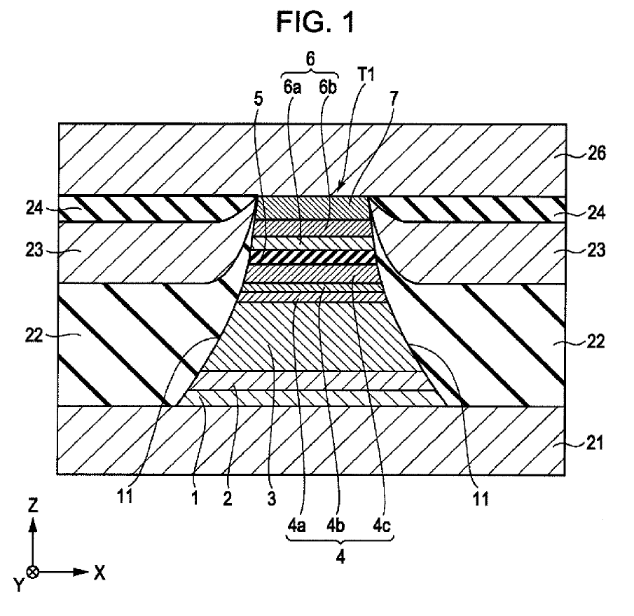

FIG. 1 is a sectional view of a tunneling magnetic sensor (tunneling magnetoresistive element) according to an embodiment of the present invention which is taken in a direction parallel to a surface of the magnetic sensor opposite a recording medium.

This tunneling magnetic sensor is disposed at, for example, a trailing end of a floating slider mounted on a hard disk drive to sense a recording magnetic field from a hard disk. In the drawings, the X direction indicates a track-width direction, the Y direction indicates the direction of a leakage magnetic field from a magnetic recording medium such as a hard disk (height direction), and the Z direction indicates the movement direction of the hard disk and the stacking direction of layers of the tunneling magnetic sensor.

The lowest layer shown in FIG. 1 is a lower shield layer 21 formed of, for example, a NiFe alloy. The tunneling magnetic sensor includes a multilayer part T1 disposed on the lower shield layer 21 and a lower insulating layer 22, a hard bias layer 23, and an upper insulating layer 24 which are disposed on both sides of the multilayer part T1 in the track-width direction (X direction).

The lowest layer of the multilayer part T1 is a base layer 1 formed of a nonmagnetic material, for example, at least one element selected from the group consisting of tantalum, hafnium, niobium, zirconium, titanium, molybdenum, and tungsten. A seed layer 2 is disposed on the base layer 1. The seed layer 2 is formed of a NiFeCr alloy or chromium. If a NiFeCr alloy is used, the seed layer 2 forms a face-centered cubic (fcc) structure with an equivalent crystal plane represented as a (111) plane preferentially oriented in a direction parallel to the surfaces of the layers of the multilayer part T1. If chromium is used, the seed layer 2 forms a body-centered cubic (bcc) structure with an equivalent crystal plane represented as a (110) plane preferentially oriented in the direction parallel to the surfaces of the layers of the multilayer part T1. The base layer 1 does not necessarily have to be formed.

An antiferromagnetic layer 3 is disposed on the seed layer 2. The antiferromagnetic layer 3 is preferably formed of an antiferromagnetic material containing manganese and the element X (where X is at least one element selected from the platinum-group elements, including platinum, palladium, iridium, rhodium, ruthenium, and osmium).

The XMn alloy has excellent properties as an antiferromagnetic material, including high corrosion resistance, high blocking temperature, and the capability to generate a large exchange-coupling field (Hex).

The antiferromagnetic layer 3 can also be formed of an antiferromagnetic material containing manganese, the element X, and the element X′ (where X′ is at least one element selected from the group consisting of neon, argon, krypton, xenon, beryllium, boron, carbon, nitrogen, magnesium, aluminum, silicon, phosphorus, titanium, vanadium, chromium, iron, cobalt, nickel, copper, zinc, gallium, germanium, zirconium, niobium, molybdenum, silver, cadmium, tin, hafnium, tantalum, tungsten, rhenium, gold, lead, and rare earth elements).

A pinned magnetic layer (first magnetic layer) 4 is disposed on the antiferromagnetic layer 3. The pinned magnetic layer 4 has a multilayer ferrimagnetic structure including, from bottom to top, a first pinned magnetic layer 4a, a nonmagnetic intermediate layer 4b, and a second pinned magnetic layer 4c. In the multilayer ferrimagnetic structure, the magnetization directions of the first pinned magnetic layer 4a and the second pinned magnetic layer 4c become antiparallel under the action of an exchange-coupling field generated at the interface between the antiferromagnetic layer 3 and the pinned magnetic layer 4 and an antiferromagnetic exchange-coupling field generated through the nonmagnetic intermediate layer 4b (RKKY-like exchange interaction). This structure can stabilize the magnetization of the pinned magnetic layer 4 and apparently enhance the exchange-coupling field generated at the interface between the antiferromagnetic layer 3 and the pinned magnetic layer 4. The first pinned magnetic layer 4a and the second pinned magnetic layer 4c each have a thickness of, for example, about 12 to 24 Å. The nonmagnetic intermediate layer 4b has a thickness of, for example, about 8 to 10 Å.

The first pinned magnetic layer 4a and the second pinned magnetic layer 4c are formed of a ferromagnetic material such as a CoFe alloy, a NiFe alloy, or a CoFeNi alloy. The nonmagnetic intermediate layer 4b is formed of a nonmagnetic conductive material such as ruthenium, rhodium, iridium, chromium, rhenium, or copper.

An insulating barrier layer 5 is disposed on the pinned magnetic layer 4. The insulating barrier layer 5 is formed of titanium magnesium oxide (TiMgO).

A free magnetic layer (second magnetic layer) 6 is disposed on the insulating barrier layer 5. The free magnetic layer 6 includes a soft magnetic layer 6b formed of a magnetic material such as a NiFe alloy and an enhancement layer 6a disposed between the insulating barrier layer 5 and the soft magnetic layer 6b and formed of, for example, a CoFe alloy. The soft magnetic layer 6b is preferably formed of a magnetic material with excellent soft magnetic properties. The enhancement layer 6a is preferably formed of a magnetic material having a higher spin polarizability than the soft magnetic layer 6b. The use of a magnetic material having high spin polarizability, such as a CoFe alloy, contributes to an increase in the rate of resistance change (ΔR/R).

The free magnetic layer 6 may have a multilayer ferrimagnetic structure including magnetic layers and a nonmagnetic intermediate layer disposed therebetween. The width of the free magnetic layer 6 in the track-width direction (X direction) is defined as track width, Tw.

A protective layer 7 is disposed on the free magnetic layer 6. The protective layer 7 is formed of, for example, tantalum.

The multilayer part T1 has side surfaces 11 on both sides thereof in the track-width direction (X direction). These side surfaces 11 are sloped such that the width of the multilayer part T1 in the track-width direction decreases gradually from bottom to top.

In FIG. 1, the lower insulating layer 22 is disposed on the lower shield layer 21 and the side surfaces 11 of the multilayer part T1. The hard bias layer 23 is disposed on the lower insulating layer 22. The upper insulating layer 24 is disposed on the hard bias layer 23.

A bias base layer (not shown) can be disposed between the lower insulating layer 22 and the hard bias layer 23. The bias base layer is formed of, for example, chromium, tungsten, or titanium.

The insulating layers 22 and 24 are formed of an insulating material such as Al₂O₃ or SiO₂. These insulating layers 22 and 24 insulate the top and bottom of the hard bias layer 23 to prevent a current flowing through the interfaces of the layers of the multilayer part T1 perpendicularly from being shunted to the sides of the multilayer part T1 in the track-width direction. The hard bias layer 23 is formed of, for example, a CoPt alloy or a CoCrPt alloy.

An upper shield layer 26 is formed on the multilayer part T1 and the upper insulating layer 24. The upper shield layer 26 is formed of, for example, a NiFe alloy,

In the embodiment shown in FIG. 1, the lower shield layer 21 and the upper shield layer 26 function as electrode layers for the multilayer part T1. A current flows through the surfaces of the layers of the multilayer part T1 perpendicularly (in a direction parallel to the Z direction).

The free magnetic layer 6 is magnetized in a direction parallel to the track-width direction (X direction) by the action of a bias magnetic field from the hard bias layer 23, On the other hand, the first pinned magnetic layer 4a and second pinned magnetic layer 4c of the pinned magnetic layer 4 are magnetized in a direction parallel to the height direction (Y direction). In the multilayer ferrimagnetic structure of the pinned magnetic layer 4, the magnetization of the first pinned magnetic layer 4a is antiparallel to that of the second pinned magnetic layer 4c. While the magnetization of the pinned magnetic layer 4 is fixed (not changed by an external magnetic field), the magnetization of the free magnetic layer 6 is changed by an external magnetic field.

If the magnetization of the free magnetic layer 6 becomes antiparallel to that of the second pinned magnetic layer 4c under the action of an external magnetic field, a tunneling current flowing through the insulating barrier layer 5 is minimized, meaning that the resistance is maximized. If the magnetization of the free magnetic layer 6 becomes parallel to that of the second pinned magnetic layer 4c, the tunneling current is maximized, meaning that the resistance is minimized.

Based on this principle, a change in electrical resistance is detected as a voltage change when an external magnetic field changes the magnetization of the free magnetic layer 6. The tunneling magnetic sensor thus senses a leakage magnetic field from a recording medium.

The magnetic sensor according to the embodiment shown in FIG. 1 is characterized in that the insulating barrier layer 5 is formed of TiMgO and contains magnesium in an amount of about 4 to 20 atomic percent based on 100 atomic percent of the total content of titanium and magnesium,

This magnetic sensor can provide a higher rate of resistance change (ΔR/R) at a lower RA than known tunneling magnetic sensors.

In this embodiment, the TiMgO insulating barrier layer 5 does not have a high concentration of magnesium. An insulating barrier layer having a high concentration of magnesium is found to have a lower rate of resistance change (ΔR/R) than a titanium oxide (TiO) insulating barrier layer within the same range of RA. In this embodiment, as S described above, the concentration of magnesium is controlled within the range of about 4 to 20 atomic percent based on 100 atomic percent of the total content of titanium and magnesium.

Magnesium oxide (MgO) and TiO have been studied as materials for insulating barrier layers. MgO is more capable of increasing the rate of resistance change (ΔR/R) than TiO, although MgO has problems such as high RA and a deliquescent property. On the other hand, TiO can provide a relatively high rate of resistance change (ΔR/R) within a low range of RA.

In this embodiment, the insulating barrier layer 5 is formed of a material modified so as to provide a higher rate of resistance change (ΔR/R) than TiO within the same range of RA.

The value of RA, which is extremely important in terms of, for example, appropriate high-speed data transmission, must be suppressed to a low level. Specifically, the RA should be controlled within the range of about 2 to 7 Ωμm², preferably about 2 to 5 Ωμm², more preferably about 2 to 4 Ωμm², most preferably about 2 to 3 Ωμm².

If the magnesium concentration of the insulating barrier layer 5 falls within the range described above, the insulating barrier layer 5 can achieve low RA and a higher rate of resistance change (ΔR/R) within a low range of RA than a TiO layer. Specifically, the insulating barrier layer 5 can achieve a rate of resistance change (ΔR/R) of about 20% or more, preferably about 25% or more. In addition, the insulating barrier layer 5 does not have a deliquescent property.

More preferably, the insulating barrier layer 5 has a magnesium concentration of about 4 to 15 atomic percent. If the magnesium concentration is 15 atomic percent or less, the insulating barrier layer 5 can more effectively provide a high rate of resistance change (ΔR/R).

Still more preferably, the insulating barrier layer 5 has a magnesium concentration of about 4.5 atomic percent or more. In this case, the insulating barrier layer 5 can more effectively provide a rate of resistance change (ΔR/R) of about 20% or more.

Next, the structure of the insulating barrier layer 5 will be described.

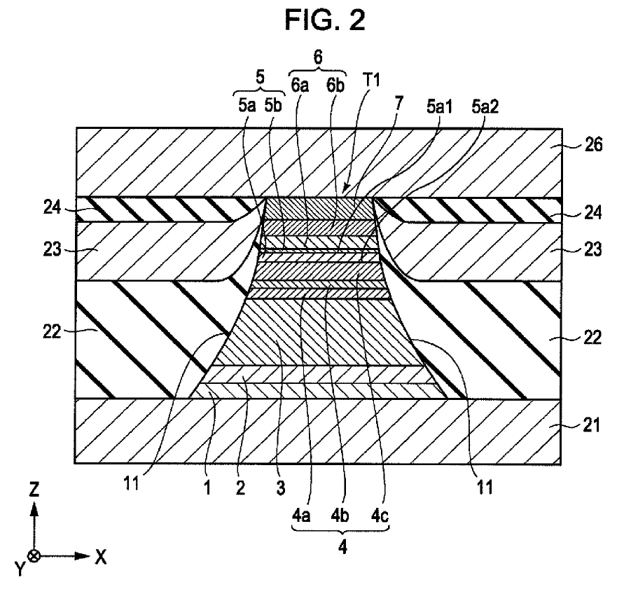

For example, the insulating barrier layer 5 has a multilayer structure shown in FIG. 2. This multilayer structure includes a TiO layer 5a and a MgO layer 5b.

In FIG. 2, the TiO layer 5a is thicker than the MgO layer 5b.

As in the case of FIG. 1, the insulating harrier layer 5 shown in FIG. 2 contains magnesium in an amount of about 4 to 20 atomic percent based on 100 atomic percent of the total content of titanium and magnesium. That is, the thicknesses of the TiO layer 5a and the MgO layer 5b are controlled so that the magnesium concentration of the insulating barrier layer 5 falls within the range of about 4 to 20 atomic percent.

The insulating barrier layer 5 preferably has an average thickness of about 10 to 20 Å to successfully inhibit, for example, a sharp rise in sensor resistance and formation of pinholes. The magnesium concentration of the insulating barrier layer 5 falls within the range of about 4 to 20 atomic percent if the thickness of the MgO layer 5b is about 5% to 25% of the total thickness of the insulating barrier layer 5. Specifically, the MgO layer 5b has an average thickness of about 0.5 to 5.0 Å.

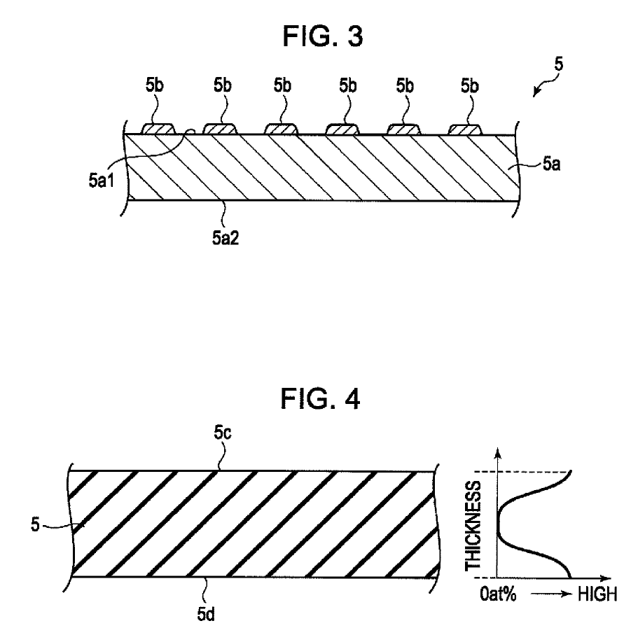

Thus, the MgO layer 5b is extremely thin. In FIG. 2, the MgO layer 5b is illustrated as covering the entire top surface 5a1 of the TiO layer 5a; in practice, the MgO layer 5b is discontinuously formed on the top surface 5a1 of the TiO layer 5a, as shown in FIG. 3.

The MgO layer 5b, which is formed on the top surface 5a1 of the TiO layer 5a in FIGS. 2 and 3, may be formed on the bottom surface 5a2 of the TiO layer 5a (i.e., on the top surface of the second pinned magnetic layer 4c). Also, the MgO layer 5b may be formed on each of the surfaces 5a1 and 5a 2 of the TiO layer 5a.

Alternatively, the MgO layer 5b may be formed inside the TiO layer 5a. That is, the MgO layer 5b may be formed in at least one site of the inside, top surface 5a1, and bottom surface 5a2 of the TiO layer 5a.

Preferably, the MgO layer 5b is formed on one or both of the top surface 5a1 and bottom surface 5a2 of the TiO layer 5a to successfully increase the rate of resistance change (ΔR/R). The MgO layer 5b is more capable of increasing the rate of resistance change (ΔR/R) than the TiO layer 5a. The sites where the MgO layer 5b most effectively contributes to an increase in the rate of resistance change (ΔR/R) are the vicinities of the interfaces between the insulating barrier layer 5 and the pinned magnetic layer 4 and between the insulating barrier layer 5 and the free magnetic layer 6. Accordingly, the rate of resistance change (ΔR/R) can be effectively increased by forming the extremely thin MgO layer 5b at one or both of the interfaces between the insulating barrier layer 5 and the pinned magnetic layer 4 and between the insulating barrier layer 5 and the free magnetic layer 6.

Referring to FIG. 4, alternatively, the insulating barrier layer 5 may have a region where the concentration of magnesium varies in the thickness direction (Z direction). Unlike FIGS. 2 and 3, the interface between the TiO layer 5a and the MgO layer 5b is not clearly defined in FIG. 4. The region where the concentration of magnesium varies is formed inside the single insulating barrier layer 5 through interdiffusion of titanium and magnesium. In practice, such a region tends to be formed through interdiffusion of titanium and magnesium during, for example, annealing.

The graph on the right side of FIG. 4 shows the relationship between the concentration of magnesium, represented by the horizontal axis, and the position along the thickness of the insulating barrier layer 5, represented by the vertical axis, A curve on the graph indicates variations in the concentration of magnesium. According to FIG. 4, the concentration of magnesium is maximized near the top surface 5c and bottom surface 5d of the insulating barrier layer 5 and decreases gradually toward the center of the insulating barrier layer 5 in the thickness direction.

In FIG. 4, the region where the concentration of magnesium varies in the thickness direction has a high concentration of MgO near the top surface 5c and bottom surface 5d of the insulating barrier layer 5. This effectively increases the rate of resistance change (ΔR/R).

The region where the concentration of magnesium varies is not limited to the pattern represented by the graph of FIG. 4. For example, the concentration of magnesium may be maximized near the center of the insulating barrier layer 5 in the thickness direction. The insulating barrier layer 5 is preferably formed so that magnesium does not diffuse over the entire insulating barrier layer 5, but in the vicinities of the top surface 5c and bottom surface 5d of the insulating barrier layer 5 as shown in FIG. 4, with only TiO contained in the center of the insulating barrier layer 5 in the thickness direction.

The insulating barrier layer 5 may also be formed by oxidizing a TiMg alloy layer. In this case, a region where the concentration of magnesium varies as shown in FIG. 4 is not defined inside the insulating barrier layer 5, but titanium and magnesium are substantially homogeneously distributed over the insulating barrier layer 5.

The insulating barrier layer 5 may have an amorphous structure, a crystalline structure, or a mixture thereof. Examples of the crystalline structure include a rutile structure, a body-centered cubic structure, and a body-centered tetragonal structure. The enhancement layer 6a disposed on the insulating barrier layer 5 is formed of, for example, a body-centered cubic structure of Co_{100-y}Fe_{y} (where the content of iron, y, ranges from about 30 to 100 atomic percent) to effectively increase the rate of resistance change (ΔR/R). If the insulating barrier layer 5 has a rutile structure, a body-centered cubic structure, or a body-centered tetragonal structure, the lattice matching between the insulating barrier layer 5 and the enhancement layer 6a can be improved to effectively increase the rate of resistance change (ΔR/R).

In this embodiment, as described above, the insulating barrier layer 5 is formed of TiMgO and contains magnesium in an amount of about 4 to 20 atomic percent based on 100 atomic percent of the total content of titanium and magnesium. In this case, a rutile structure, a body-centered cubic structure, or a body-centered tetragonal structure tends to be stable as the crystalline structure of the insulating barrier layer 5.

The second pinned magnetic layer 4c preferably has a lower iron concentration than the enhancement layer 6a. This inhibits oxidation of iron in the second pinned magnetic layer 4c during the oxidation of the insulating barrier layer 5. In addition, if the enhancement layer 6a has a higher iron concentration than the second pinned magnetic layer 4c, the enhancement layer 6a can attract oxygen from near the interface between the second pinned magnetic layer 4c and the insulating barrier layer 5 (i.e., a reduction reaction occurs in the second pinned magnetic layer 4c). This increases the spin polarizability of the second pinned magnetic layer 4c.

The second pinned magnetic layer 4c is preferably formed of a face-centered cubic structure of Co₁₀₀₋ₓFeₓ (where the content of iron, x, ranges from about 0 to 20 atomic percent).

In FIG. 1, the antiferromagnetic layer 3, the pinned magnetic layer 4, the insulating barrier layer 5, and the free magnetic layer 6 are formed in that order, although they may also be formed in the reverse order.

Alternatively, a dual tunneling magnetic sensor can be formed which includes, from bottom to top, a lower antiferromagnetic layer, a lower pinned magnetic layer, a lower insulating barrier layer, a free magnetic layer, an upper insulating barrier layer, an upper pinned magnetic layer, and an upper antiferromagnetic layer.

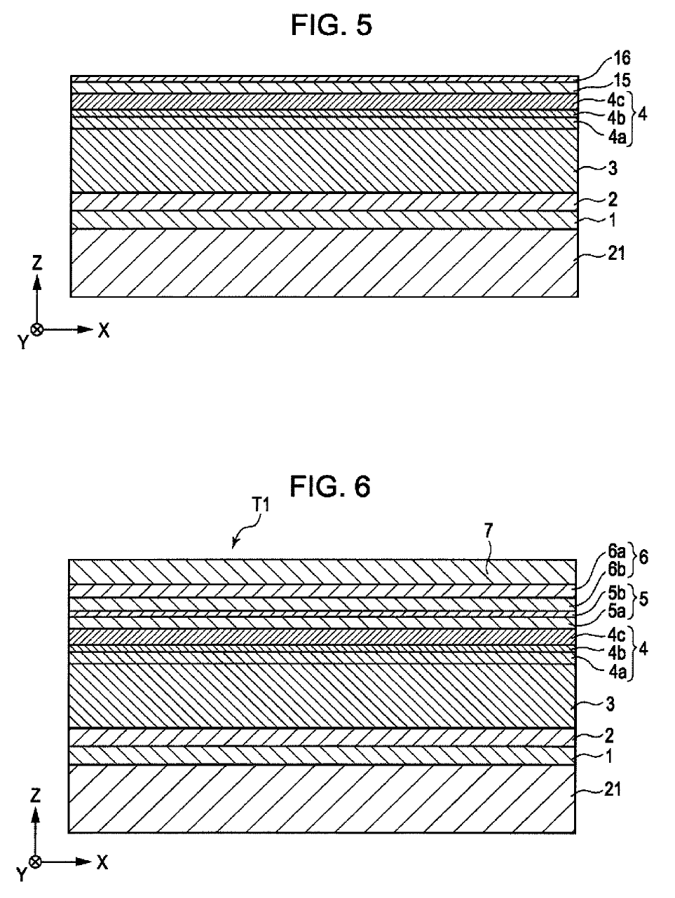

A process for producing the tunneling magnetic sensor according to this embodiment will be described. FIGS. 5 to 8 are partial sectional views of the tunneling magnetic sensor during the production process, which are taken in the same direction as FIG. 1.

In the step shown in FIG. 5 the base layer 1, the seed layer 2, the antiferromagnetic layer 3, the first pinned magnetic layer 4a, the nonmagnetic intermediate layer 4b, and the second pinned magnetic layer 4c are successively formed on the lower shield layer 21.

A titanium layer 15 is formed on the second pinned magnetic layer 4c by, for example, sputtering. A magnesium layer 16 is then formed on the titanium layer 15 by, for example, sputtering.

In this embodiment, the thicknesses of the titanium layer 15 and the magnesium layer 16 are controlled so that the concentration of magnesium falls within the range of about 4 to 20 atomic percent based on 100 atomic percent of the total content of titanium and magnesium. The thickness control is based on the assumption that the titanium layer 15 and the magnesium layer 16 are totally oxidized in the subsequent step. The densities of titanium and magnesium used to calculate the concentrations thereof from the thicknesses thereof are about 4.5 g/cm³ and about 1.738 g/cm³, respectively.

If, for example, the average total thickness of the titanium layer 15 and the magnesium layer 16 falls within the range of about 4 to 7 Å, the average thickness of the magnesium layer 16 (or the average total thickness of magnesium layers 16) is controlled within the range of about 0.3 to 2.0 Å. Because the magnesium layer 16 is extremely thin, the magnesium layer 16 is not formed over the entire surface of the titanium layer 15, but is discontinuously formed thereon.

Preferably, the thicknesses of the titanium layer 15 and the magnesium layer 16 are controlled so that the concentration of magnesium falls within the range of about 4 to 15 atomic percent based on 100 atomic percent of the total content of titanium and magnesium. If, for example, the average total thickness of the titanium layer 15 and the magnesium layer 16 falls within the range of about 4 to 7 Å, the average thickness of the magnesium layer 16 (or the average total thickness of magnesium layers 16) is preferably controlled within the range of about 0.3 to 1.5 Å. More preferably, the thickness of the magnesium layer 16 is about 1.0 Å or less.

The titanium layer 15 and the magnesium layer 16 are totally oxidized by introducing oxygen into a vacuum chamber to form the insulating barrier layer 5, which includes the TiO layer 5a and the MgO layer 5b. The insulating barrier layer 5 contains magnesium in an amount of about 4 to 20 atomic percent, preferably about 4 to 15 atomic percent, based on 100 atomic percent of the total content of titanium and magnesium.

The free magnetic layer 6, which includes the enhancement layer 6a and the soft magnetic layer 6b, and the protective layer 7 are formed on the insulating barrier layer 5. Thus, the multilayer part T1 including the above layers is formed (see FIG. 6).

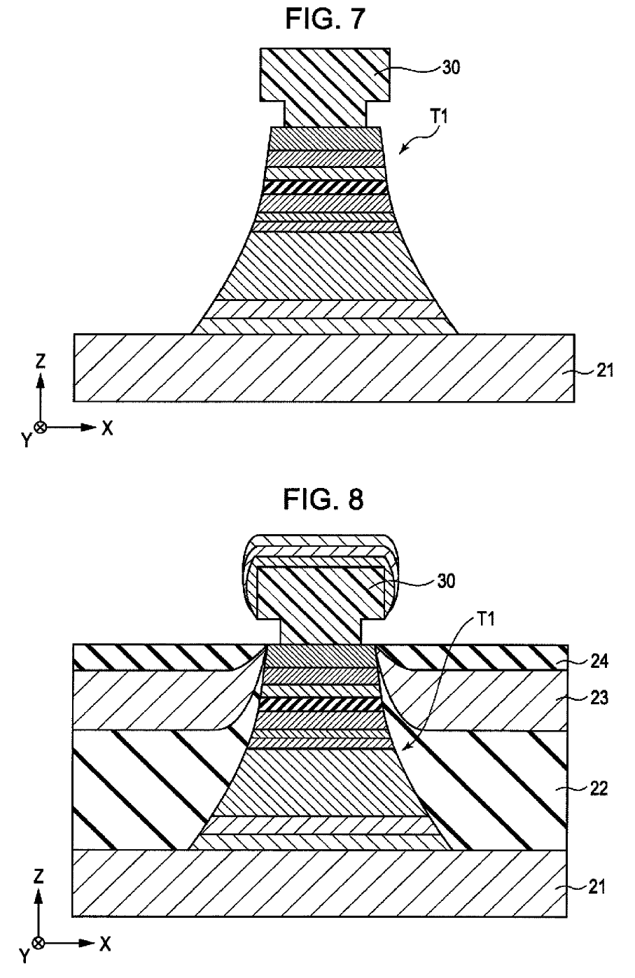

A resist layer 30 for lifting off is formed on the multilayer part T1. Side portions of the multilayer part T1 which are not covered with the resist layer 30 in the track-width direction (X direction) are removed by, for example, etching (see FIG. 7).

The lower insulating layer 22, the hard bias layer 23, and the upper insulating layer 24 are sequentially formed on the lower shield layer 21 on both sides of the multilayer part T1 in the track-width direction (see FIG. 8).

The resist layer 30 is removed before the upper shield layer 26 is formed on the multilayer part T1 and the upper insulating layer 24.

The above process for producing the tunneling magnetic sensor involves annealing, typically, an annealing step for inducing an exchange-coupling field (Hex) between the antiferromagnetic layer 3 and the first pinned magnetic layer 4a.

The annealing step tends to cause interdiffusion of titanium and magnesium contained in the insulating barrier layer 5, thus forming a region where the concentration of magnesium varies. The insulating barrier layer 5 of the tunneling magnetic sensor produced through the steps shown in FIGS. 5 to 8 tends to have a region where the concentration of magnesium decreases gradually from the top surface 5c to the center of the insulating barrier layer 5 in the thickness direction.

The magnesium layer 16 is formed on top of the titanium layer 15 in the step shown in FIG. 5, although the multilayer structure of the insulating barrier layer 5 is not limited to any particular structure other examples include a structure including a titanium layer disposed on top of a magnesium layer, a structure including two magnesium layers and a titanium layer disposed therebetween, and a structure including two titanium layers and a magnesium layer disposed therebetween. Also, the number and stacking order of layers are not limited as long as the concentration of magnesium falls with the range of about 4 to 20 atomic percent based on 100 atomic percent of the total content of titanium and magnesium.

Preferably, the magnesium layer 16 is formed on the top surface or bottom surface of the titanium layer 15 so that the concentration of magnesium is higher near the top surface 5c or bottom surface 5d of the insulating barrier layer 5 than in the center of the insulating barrier layer 5 in the thickness direction. Such a structure can successfully increase the rate of resistance change (ΔR/R).

In the step shown in FIG. 5, alternatively, a TiMgO layer may be formed as the insulating barrier layer 5 by oxidizing a TiMg alloy layer formed on the second pinned magnetic layer 4c. The concentration of magnesium in the TiMg alloy layer is controlled within the range of about 4 to 20 atomic percent, preferably about 4 to 15 atomic percent.

The method used for oxidation may be, for example, radical oxidation, ion oxidation, plasma oxidation, or spontaneous oxidation. For example, radical oxidation is performed for about 100 to 400 seconds.

A tunneling magnetic sensor including, from bottom to top, a free magnetic layer, an insulating barrier layer, a pinned magnetic layer, and an antiferromagnetic layer and a dual tunneling magnetic sensor can be produced as in the process illustrated in FIGS. 5 to 8.

### EXAMPLES

Tunneling magnetic sensors having the structure shown in FIG. 1 were produced.

The multilayer part T1 was formed by forming the base layer 1, the seed layer 2, the antiferromagnetic layer 3, the pinned magnetic layer 4, the insulating harrier layer 5, the free magnetic layer 6, a ruthenium layer having an average thickness of about 20 Å, and the protective layer 7 in the above order. The base layer 1 was formed of tantalum and had an average thickness of about 30 Å. The seed layer 2 was formed of NiFeCr and had an average thickness of about 50 Å. The antiferromagnetic layer 3 was formed of IrMn and had an average thickness of about 70 Å. The first pinned magnetic layer 4a was formed of Co_{70at%}Fe_{30at%} and had an average thickness of about 14 Å. The nonmagnetic intermediate layer 4b was formed of ruthenium and had an average thickness of about 9.1 Å. The second pinned magnetic layer 4c was formed of Co_{90at%}Fe₁₀ₐₜₛ and had an average thickness of about 18 Å. The enhancement layer 6a was formed of Fe_{90at%}Co_{10at%} and had an average thickness of about 10 Å. The soft magnetic layer 6b was formed of Ni_{86at%}Fe_{14at%} and had an average thickness of about 40 Å. The protective layer 7 was formed of tantalum and had an average thickness of about 180 Å.

After the multilayer part T1 was formed, it was annealed at about 270° C. for about 3 hours and 40 minutes.

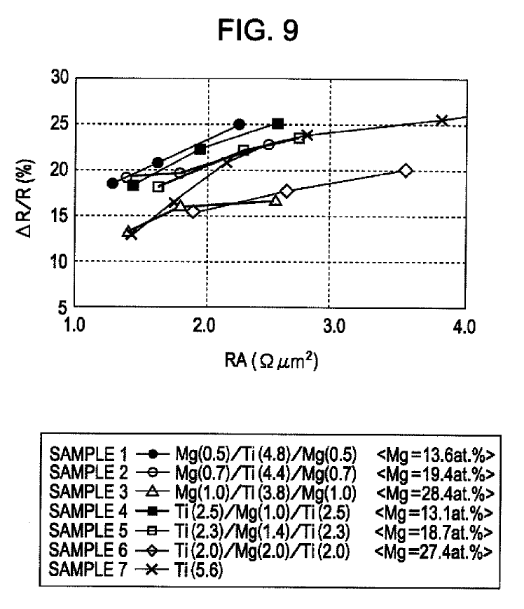

In Samples 1 to 6, a TiMgO layer was formed as the insulating barrier layer 5 by forming a multilayer structure of magnesium and titanium on the pinned magnetic layer 4 and totally oxidizing the multilayer structure. In Sample 7, a TiO layer was formed as the insulating barrier layer 5 by forming only a titanium layer on the pinned magnetic layer 4 and oxidizing the titanium layer. In FIG. 9, the values in parentheses indicate the average thicknesses (unit: Å) of titanium layers and magnesium layers before oxidation, and the concentrations of magnesium are based on 100 atomic percent of the total content of titanium and magnesium under the assumption that titanium and magnesium were totally diffused. All samples were subjected to radical oxidation for a predetermined period of time (hundreds of seconds),

The graph of FIG. 9 shows that Samples 3 and 6 had lower rates of resistance change (ΔR/R) than Sample 7 within the same range of RA. These results demonstrated that the samples having a magnesium concentration of more than about 20 atomic percent had lower rates of resistance change (ΔR/R) than Sample 7.

The remaining four samples, namely, Samples 1, 2, 4, and 5, had magnesium concentrations of less than about 20 atomic percent. These samples had higher rates of resistance change (ΔR/R) than Sample 7 within the same range of RA. Sample 1 had nearly the same magnesium concentration as Sample 4 but exhibited a higher rate of resistance change (ΔR/R) than Sample 4. Also Sample 2 had nearly the same magnesium concentration as Sample 5 but exhibited a higher rate of resistance change (ΔR/R) than Sample 5.

In Samples 1 and 2, extremely thin magnesium layers were formed on the top and bottom surfaces of a titanium layer. Accordingly, MgO layers were formed at the interfaces between a TiO layer and the second pinned magnetic layer 4c and between the TiO layer and the free magnetic layer 6. These results demonstrated that the rate of resistance change (ΔR/R) can be increased by forming MgO layers at the interfaces between a TiO layer and a second pinned magnetic layer and between the TiO layer and a free magnetic layer (in practice, regions with a higher concentration of magnesium than the center of the insulating barrier layer in the thickness direction are formed near the interfaces after diffusion).

The insulating barrier layers of the samples tested in the experiment of FIG. 9, namely, Samples 1 to 6, had three-layer structures of titanium and magnesium. In the next experiment, samples including insulating barrier layers having two-layer structures were tested.

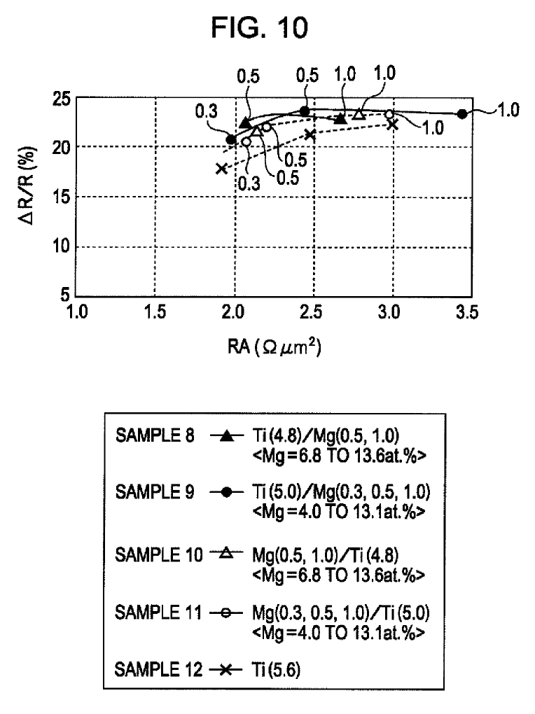

The basic film structure of the multilayer part T1 and the annealing conditions were the same as above. In Samples 8 to 11, a TiMgO layer was formed as the insulating barrier layer 5 by forming a multilayer structure of magnesium and titanium on the second pinned magnetic layer 4c, as shown in FIG. 10, and totally oxidizing the multilayer structure. In Sample 12, a TiO layer was formed as the insulating barrier layer 5 by forming only a titanium layer on the second pinned magnetic layer 4c and oxidizing the titanium layer. In FIG. 10, the values in parentheses indicate the average thicknesses (unit: Å) of titanium layers and magnesium layers before oxidation, and the concentrations of magnesium are based on 100 atomic percent of the total content of titanium and magnesium. As shown in FIG. 10, Samples 8 and 10 were tested with the thickness of the magnesium layer being about 0.5 and 1 Å, and Samples 9 and 11 were tested with the thickness of the magnesium layer being about 0.3, 0.5, and 1 Å (the values on the graph of FIG. 10 indicate the thicknesses of the magnesium layers). Samples 8 to 11 were subjected to radical oxidation for a predetermined period of time (hundreds of seconds). Sample 12 was tested with variations in the period of time for radical oxidation.

As shown in FIG. 10, the insulating barrier layers 5 of Samples 8 to 11 were formed by oxidizing a two-layer structure of titanium and magnesium. Samples 8 to 11 had higher rates of resistance change (ΔR/R) than Sample 12 within the same range of RA. These results demonstrated that the rate of resistance change (ΔR/R) can be increased by forming an extremely thin MgO layer on at least one of the top and bottom surfaces of a TiO layer.

Next, various multilayer structures of insulating barrier layers shown in Table 1 were tested for RA and the rate of resistance change (ΔR/R). The basic film structure of the multilayer part T1 and the annealing conditions were the same as above. As shown in Table 1, the insulating barrier layers of the samples were formed by totally oxidizing a multilayer structure of titanium and magnesium or oxidizing a single titanium layer. The leftmost layers of the insulating barrier layers shown in Table 1 were adjacent to the second pinned magnetic layers while the rightmost layers were adjacent to the free magnetic layers. That is, the titanium layers and the magnesium layers were formed in order from the left to right of Table 1. Table 1 also shows the thicknesses of the titanium layers and the magnesium layers (unit: Å). For the sample of Example 5, for instance, a titanium layer having a thickness of about 4.6 Å and a magnesium layer having a thickness of about 1.0 Å were formed in that order. These samples were subjected to radical oxidation for a predetermined period of time (hundreds of seconds), although the samples having the same magnesium concentration were tested with variations in the period of time for radical oxidation within the range of tens of seconds.

TABLE 1

| | Barrier layer (left: second pinned | | | | | | | | | |
|---|---|---|---|---|---|---|---|---|---|---|
| | magnetic layer side) | | | | | | | | | |
| | | | | | | | | Mg | | |
| | Ti | Mg | Ti | Mg | Ti | Mg | Total | (at | RA | ΔR/R |
| | (Å) | (Å) | (Å) | (Å) | (Å) | (Å) | (Å) | %) | (Ωμm²) | (%) |
| Comparative | | | | | 4.6 | | 4.6 | 0.0 | 1.39 | 8.46 |
| Example 1 | | | | | | | | | | |
| Example 1 | | | | | 4.6 | 0.3 | 4.9 | 4.7 | 1.59 | 16.10 |
| Example 2 | | | | | 4.6 | 0.5 | 5.1 | 7.6 | 1.78 | 17.81 |
| Example 3 | | | | | 4.6 | 0.5 | 5.1 | 7.6 | 1.75 | 19.27 |
| Example 4 | | | | | 4.6 | 0.5 | 5.1 | 7.6 | 2.03 | 20.22 |
| Example 5 | | | | | 4.6 | 1.0 | 5.6 | 14.1 | 2.77 | 23.80 |
| Comparative | | | | | 4.8 | | 4.8 | 0.0 | 1.54 | 13.66 |
| Example 2 | | | | | | | | | | |
| Example 6 | | | | | 4.8 | 0.5 | 5.3 | 7.3 | 1.95 | 21.18 |
| Example 7 | | | | | 4.8 | 0.5 | 5.3 | 7.3 | 2.07 | 22.68 |
| Example 8 | | | | | 4.8 | 0.5 | 5.3 | 7.3 | 2.56 | 22.83 |
| Example 9 | | | | | 4.8 | 1.0 | 5.8 | 13.6 | 2.66 | 23.04 |
| Example 10 | | | | | 5.0 | 0.3 | 5.3 | 4.3 | 1.98 | 20.80 |
| Example 11 | | | | | 5.0 | 0.5 | 5.5 | 7.0 | 2.44 | 23.81 |
| Example 12 | | | | | 5.0 | 1.0 | 6.0 | 13.1 | 3.44 | 23.50 |
| Comparative | | | 4.8 | | | | 4.8 | 0.0 | 2.15 | 13.16 |
| Example 3 | | | | | | | | | | |
| Example 13 | | 0.3 | 4.8 | 0.3 | | | 5.4 | 8.6 | 3.96 | 26.94 |
| Example 14 | | 0.5 | 4.8 | 0.5 | | | 5.8 | 13.6 | 4.51 | 28.07 |
| Example 15 | | 0.7 | 4.8 | 0.7 | | | 6.2 | 18.0 | 5.85 | 25.61 |
| Example 16 | | 0.3 | 5.0 | 0.3 | | | 5.6 | 8.3 | 3.30 | 26.59 |
| Example 17 | | 0.3 | 5.0 | 0.3 | | | 5.6 | 8.3 | 4.21 | 26.89 |
| Example 18 | | 0.3 | 5.0 | 0.3 | | | 5.6 | 8.3 | 4.10 | 27.11 |
| Example 19 | | 0.5 | 5.0 | 0.5 | | | 6.0 | 13.1 | 5.06 | 26.98 |
| Example 20 | | 0.7 | 5.0 | 0.7 | | | 6.4 | 17.4 | 6.54 | 26.15 |
| Example 21 | | 0.2 | 2.5 | 0.2 | 2.5 | 0.2 | 5.6 | 8.3 | 3.46 | 26.71 |
| Example 22 | | 0.2 | 2.5 | 0.2 | 2.5 | 0.2 | 5.6 | 8.3 | 3.94 | 26.31 |
| Example 23 | | 0.2 | 2.5 | 0.2 | 2.5 | 0.2 | 5.6 | 8.3 | 4.57 | 27.18 |
| Example 24 | | 0.3 | 2.5 | 0.3 | 2.5 | 0.3 | 5.9 | 12.0 | 4.20 | 24.93 |
| Example 25 | | | 2.5 | 0.5 | 2.5 | | 5.5 | 7.0 | 3.78 | 25.92 |
| Example 26 | | | 2.5 | 1.0 | 2.5 | | 6.0 | 13.1 | 4.92 | 27.90 |
| Example 27 | 1.7 | 0.3 | 1.6 | 0.3 | 1.7 | | 5.6 | 8.3 | 4.11 | 28.54 |
| Example 28 | 1.7 | 0.5 | 1.6 | 0.5 | 1.7 | | 6.0 | 13.1 | 4.81 | 25.58 |

Table 1 shows the magnesium concentration (atomic percent) of each sample based on 100 atomic percent of the total content of titanium and magnesium.

Table 1 shows that the samples of Examples 1 to 28 had higher rates of resistance change (ΔR/R) than those of Comparative Examples 1 to 3. Specifically, the samples of Examples 1 to 28 had rates of resistance change (ΔR/R) of more than about 15%. Most of these samples had rates of resistance change (ΔR/R) of more than about 20%, and some samples had rates of resistance change (ΔR/R) of more than about 25%.

A lower RA is preferred. In Examples 1 to 28, the RA could be controlled within the range of about 2 to 7 Ωμm², preferably about 2 to 5 Ωμm², more preferably about 2 to 4 Ωμm². In particular, the RA is preferably controlled within the range of about 2 to 4 Ωμm², most preferably about 2 to 3 Ωμm². Such an insulating barrier layer can provide a high rate of resistance change (ΔR/R) within substantially the same range of RA as those of Comparative Examples 1 to 3, which were formed of TiO.

The test results of FIGS. 9 and 10 and Table 1 demonstrated that an insulating barrier layer formed of TiMgO and containing magnesium in an amount of about 4 to 20 atomic percent, preferably about 4 to 15 atomic percent, based on 100 atomic percent of the total content of titanium and magnesium has a higher rate of resistance change (ΔR/R) than a TiO insulating barrier layer within substantially the same low range of RA.

The concentration of magnesium is preferably about 4.5 atomic percent or more, more preferably about 8.0 atomic percent or more. Such an insulating barrier layer can more stably provide a high rate of resistance change (ΔR/R).

What is claimed is:

1. A tunneling magnetic sensor comprising, from bottom to top:
a first magnetic layer;
an insulating barrier layer; and
a second magnetic layer,
wherein one of the first and second magnetic layers is a pinned magnetic layer whose magnetization direction is fixed, and the other magnetic layer is a free magnetic layer whose magnetization direction is changed by an external magnetic field, and
wherein the insulating barrier layer comprises titanium magnesium oxide (TiMgO) and contains magnesium in an amount of about 4 to 20 atomic percent based on 100 atomic percent of the total content of titanium and magnesium.

2. The tunneling magnetic sensor according to claim 1, wherein the content of magnesium is about 4 to 15 atomic percent.

3. The tunneling magnetic sensor according to claim 1, wherein the insulating barrier layer comprises a titanium oxide (TiO) layer and a magnesium oxide (MgO) layer disposed in at least one site of the inside, top surface, and bottom surface of the TiO layer.

4. The tunneling magnetic sensor according to claim 3, wherein the MgO layer is disposed on one or both of the top and bottom surfaces of the TiO layer.

5. The tunneling magnetic sensor according to claim 3, wherein the MgO layer is discontinuously formed.

6. The tunneling magnetic sensor according to claim 1, wherein the insulating barrier layer has a region where the concentration of magnesium varies in a thickness direction.

7. The tunneling magnetic sensor according to claim 6, wherein the concentration of magnesium is higher near one or both of the top and bottom surfaces of the insulating barrier layer than in the other region.

8. The tunneling magnetic sensor according to claim 1, wherein the insulating barrier layer is formed by oxidizing a TiMg alloy.

9. A process for producing a tunneling magnetic sensor, the process comprising the steps of:
(a) forming a multilayer structure including at least one titanium layer and at least one magnesium layer on a first magnetic layer, the thicknesses of the titanium layer and the magnesium layer being controlled so that the content of magnesium is about 4 to 20 atomic percent based on 100 atomic percent of the total content of titanium and magnesium;
(b) oxidizing the titanium layer and the magnesium layer to form an insulating barrier layer comprising TiMgO; and
(c) forming a second magnetic layer on the insulating barrier layer.

10. The process for producing a tunneling magnetic sensor according to claim 9, wherein in step (a), the average thickness of the multilayer structure is controlled within the range of about 4 to 7 Å, and the average thickness of the magnesium layer (or the average total thickness of the magnesium layers) is controlled within the range of about 0.3 to 2.0 Å.

11. The process for producing a tunneling magnetic sensor according to claim 9, wherein in step (a), the thicknesses of the titanium layer and the magnesium layer are controlled so that the content of magnesium is about 4 to 15 atomic percent based on 100 atomic percent of the total content of titanium and magnesium.

12. The process for producing a tunneling magnetic sensor according to claim 11, wherein in step (a), the average thickness of the multilayer structure is controlled within the range of about 4 to 7 Å, and the average thickness of the magnesium layer (or the average total thickness of the magnesium layers) is controlled within the range of about 0.3 to 1.5 Å.

13. The process for producing a tunneling magnetic sensor according to claim 9, wherein the magnesium layer is formed either between the first magnetic layer and the titanium layer or between the second magnetic layer and the titanium layer, or is formed both between the first magnetic layer and the titanium layer and between the second magnetic layer and the titanium layer.

14. The process for producing a tunneling magnetic sensor according to claim 9, wherein a TiMg alloy layer is formed on the first magnetic layer instead of the multilayer structure in step (a) and is oxidized in step (b), the TiMg alloy layer containing magnesium in an amount of about 4 to 20 atomic percent based on 100 atomic percent of the total content of titanium and magnesium.

15. The process for producing a tunneling magnetic sensor according to claim 14, wherein the TiMg alloy layer formed on the first magnetic layer in step (a) contains magnesium in an amount of about 4 to 15 atomic percent.

16. A device comprising:
a tunneling magnetic sensor, the tunneling magnetic sensor comprising, from bottom to top, a first magnetic layer; an insulating barrier layer; and a second magnetic layer,
wherein one of the first and second magnetic layers is a pinned magnetic layer whose magnetization direction is fixed, and the other magnetic layer is a free magnetic layer whose magnetization direction is changed by an external magnetic field, and
wherein the insulating barrier layer comprises titanium magnesium oxide (TiMgO) and contains magnesium in an amount of about 4 to 20 atomic percent based on 100 atomic percent of the total content of titanium and magnesium.

17. The device according to claim 16, wherein the content of magnesium is about 4 to 15 atomic percent.

18. The device according to claim 16, wherein the insulating barrier layer comprises a titanium oxide (TiO) layer and a magnesium oxide (MgO) layer disposed in at least one site of the inside, top surface, and bottom surface of the TiO layer.

19. The device according to claim 18, wherein the MgO layer is disposed on one or both of the top and bottom surfaces of the TiO layer.

20. The device according to claim 18, wherein the MgO layer is discontinuously formed.

21. The device according to claim 16, wherein the insulating barrier layer has a region where the concentration of magnesium varies in a thickness direction.

22. The device according to claim 21, wherein the concentration of magnesium is higher near one or both of the top and bottom surfaces of the insulating barrier layer than in the other region.

23. The device according to claim 16, wherein the insulating barrier layer is formed by oxidizing a TiMg alloy.
